(19) United States
(12) Patent Application Publication
(10) Pub. No.: US 2008/0169176 A1
(43) Pub. Date: Jul. 17, 2008

(54) Push-button switch structure with illumination function

(76) Inventor: Hsiu-Ling Yang, Tauyuan City (TW)

Correspondence Address: YANG, HSIU-LING, 20525 Via Talavera,, Yorba Linda, CA, 92887, US

(21) Appl. No.: 11/651,867

(22) Filed: Jan. 11, 2007

(51) Int. Cl. H01H 9/00

(52) U.S. Cl. 200/310

(57) ABSTRACT

A push-button switch structure with an illumination function includes a main frame having a panel disposed at the central area of the main frame and an installing portion disposed on said panel for installing at least one switch; a circuit board connected between the panel and the main frame for detecting an external light by a light sensor and driving at least one light emitting unit installed around the periphery of the circuit board; and a transparent cover, coupled to a lateral side of the main frame to form a cover for connecting the switch.

### FIELD OF THE INVENTION

The present invention relates to a push-button switch structure with an illumination, and more particularly to a switch structure having the functions of producing an illumination and indicating the position of a switch in the dark, regardless of the normal or abnormal condition of an external power supply.

### BACKGROUND OF THE INVENTION

Referring to FIG. 1 for the structure of a traditional push-button switch and its panel, the structure embeds at least one push-button switch 51 into a predetermined position on a switch support stand 52 and mounts the switch support stand 52 on an external side of a wire connection box on a wall, and latches a switch panel 53 having a hollow portion 531 to the switch support stand 52, so that the push-button switch 51 is exposed to the outside and covers the position around the push-button switch 51. To indicate the position of a push-button switch 51 in an environment with insufficient light or a dark place, a preferred embodiment of the push-button switch structure installs an indicating light 511 on the push-button switch 51 for users to locate the push-button switch 51 in an environment with insufficient light or at a dark place if a tiny light is emitted when the power of the push-button switch 51 is turned off to disconnect the power.

However, when the foregoing structure of the traditional push-button switch and its panel is used in practical applications, the light of the indicating light 511 can roughly indicate the position of the push-button switch only, but it cannot indicate the overall condition at the surrounding of the switch, so that users have to search for the push-button switch 51 and switch panel 53 by hands in an environment with insufficient light or at a dark place, and users generally stain the wall surface around the switch panel 53 by touches and thus affecting the artistic look of the switch. Further, the function of the traditional push-button switch is limited to be used for switching a power switch only with no other additional function and thus such switch is not competitive in the market.

In view of the shortcomings of the structure of a traditional push-button switch and its panel, the inventor of the present invention conducts researches and experiments to overcome the shortcomings, and finally invented the present invention.

### SUMMARY OF THE INVENTION

It is a primary objective of the present invention to provide a push-button switch structure with an illumination function, comprising: a main frame having a panel at central area, an installing portion disposed on the panel and installing at least one switch; a circuit board connected between the panel and the main frame for using a result of the external light detected by a light sensor to drive at least one light emitting unit installed around the periphery of the circuit board; and a transparent cover for combining a lateral side of the main frame to form a cover, and combining the switch; wherein a planned area is disposed on the surface of the transparent cover for changing the angle of refraction of the light and enhancing the effect of indicating the switch position by the light emitting unit. The circuit board further installs a second power supply unit for providing users the required electric power supplied to the light emitting unit, and providing an emergency illumination and a position indication when the electric power is disconnected or an emergency such as a power failure, a disaster drill, or even a fire occurs, or the utility power cannot be supplied normally.

The above and other objects, features and advantages of the present invention will become apparent from the following detailed description taken with the accompanying drawing.

### BRIEF DESCRIPTION OF THE DRAWINGS

FIG. 1 is a schematic view of the structure of a traditional push-button switch and its panel;

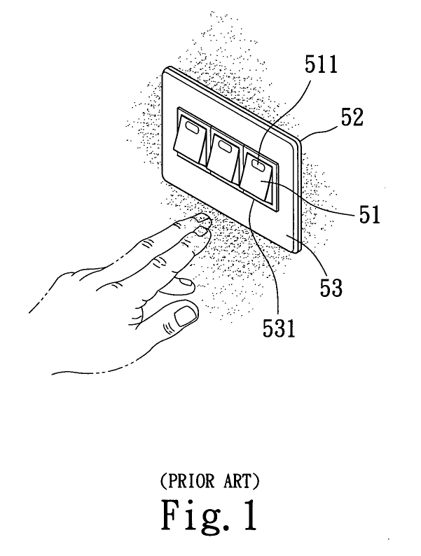

FIG. 2 is an exploded view of the structure of the present invention;

FIG. 3 is a perspective view of an overall assembly of the present invention;

FIG. 4 is a cross-sectional view of the present invention;

FIG. 5 is a schematic view of an application of the present invention; and

FIG. 6 is a schematic view of an application performed at a dark place or in a power failure situation in accordance with the present invention.

### DETAILED DESCRIPTION OF THE PREFERRED EMBODIMENTS

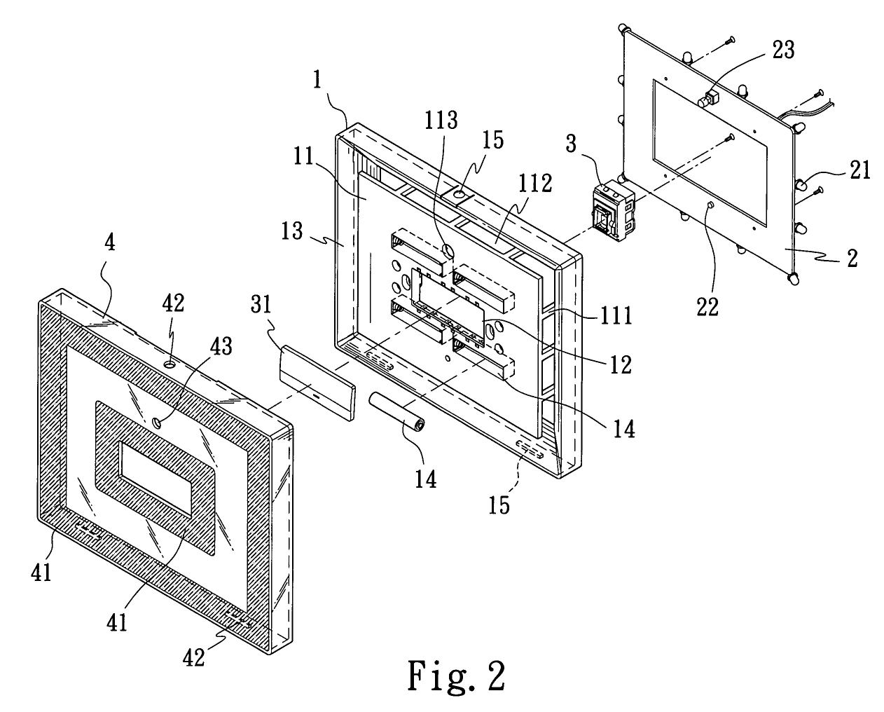

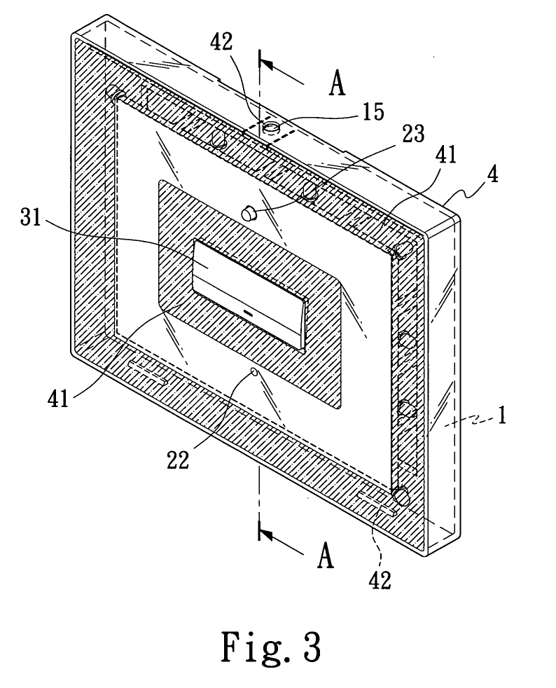

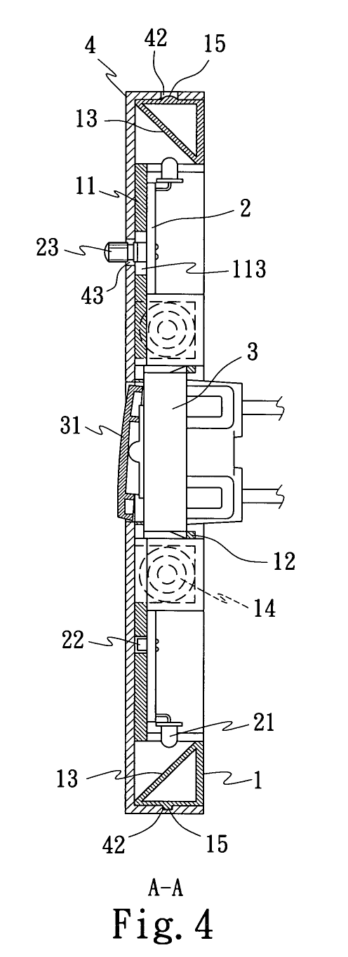

Referring FIGS. 2 to 4 for an exploded view, a perspective view and a cross-sectional of the present invention respectively, the present invention comprises: a main frame 1 having a panel 11 disposed at the central area of the main frame 1, and the panel 11 is connected and supported to a reflecting surface 13 extended obliquely inward at an internal periphery of the main frame 1 by a plurality of support stands 111, such that the surface of the panel 11 is protruded in the main frame 1 and has an installing portion 12 in form of a through hole for installing at least one switch 3 and pivotally coupled to a push-button 31 of the switch 3; a circuit board 2 is connected between the panel 11 and the main frame 1 and in the form of a square plate disposed between the installing portion 3 and the periphery of the panel 11 for detecting a result of the external light by a light sensor 22 and driving at least one light emitting unit 21 installed at the periphery of the circuit board 2; and a transparent cover 4, connected to a lateral surface of the main frame 1 by at least one fixing portion 42 and at least one fixing portion 15 disposed at the periphery of the main frame 1 to form a cover and connected to the switch 3.

The light emitting unit 21 installed at the periphery of the circuit board 2 emits light through an interval 112 formed between the panel 11 and the reflecting surface 13 and corresponds to a reflecting surface 13 extended obliquely inward at an internal periphery of the main frame 1 to produce a bright light source to the outside. In a preferred embodiment, a planned area 41 is disposed on a surface of the transparent cover 4 and gone through a transparent surface process such as a prism cutting, a wavy cutting, a fish-eye processing or a surface nebulization to form a special refractive surface for changing the angle of refraction of the light, and thus achieving the effects of enhancing the indication of a switch position and beautifying the overall artistic look of the switch.

Taking a preferred embodiment into consideration, the circuit board 2 installs a break switch 23, and the break switch 23 is passed through a through hole 113 of the panel 11 and an aperture 43 of the transparent cover 4 and exposed from the surface of a cover body for turning on or off the power supplied to the light emitting unit 21, and compulsorily shut down the light indication function of the push-button switch panel by operating the break switch 23 when a user does not need the lamp indication, such as sleeping in the nighttime or playing movies in a theater that requires complete darkness and no interference of lights. In the foregoing structure in accordance with a preferred embodiment, a configuration of having at least one battery compartment for containing related batteries to build a second power supply unit 14; wherein at least one battery compartment is disposed at an area on the surface at a periphery of the installing portion 12 of the panel 11 for providing an overall configuration to facilitate users to change batteries.

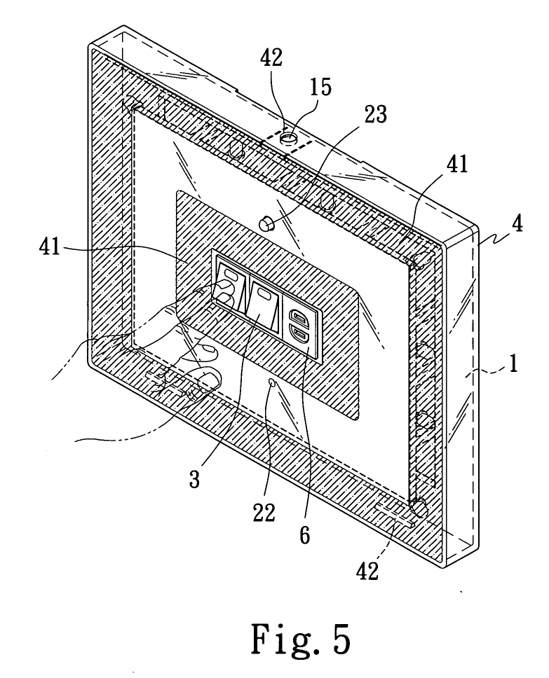

Referring to FIG. 5 for a preferred embodiment of the present invention, the installing portion 12 is coupled to a plurality of switches 3 or a power socket 6, wherein a planned area 41 is disposed on a surface adjacent to the transparent cover 4 and the installing portion 12 for covering a second power supply unit 14 on the panel 11 and beautifying the overall push-button switch panel. The panel of the switch push-button is provided for users to identify the button and prevent staining the wall. In addition, the process of manufacturing the transparent cover 4 adopts a material with a surface that is not easy to adhere dusts, such that the push-button switch can be cleaned and maintained easily after its use, and the overall effect and competitiveness of the product can be enhanced.

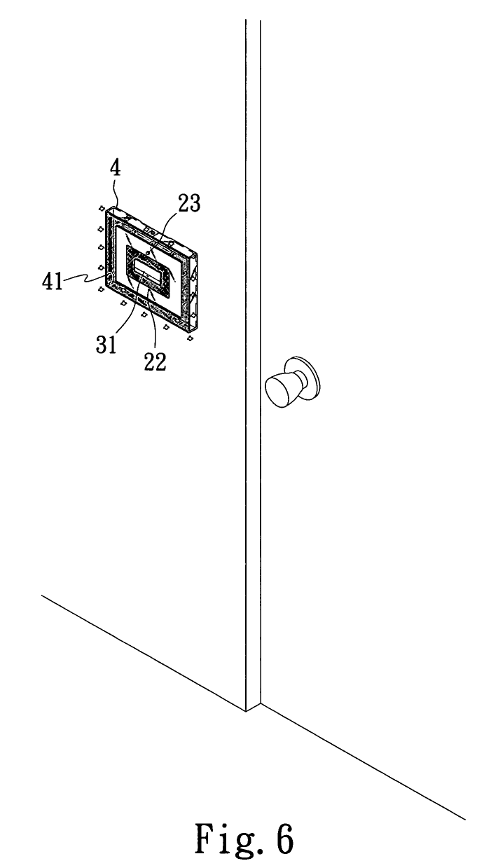

Referring to FIG. 6, a push-button switch is provided for achieving the effect of indicating the position of the push-button switch in the dark, such that when a power failure or an emergency such as a power breakdown, a disaster drill or even a fire occurs or the utility power cannot be supplied normally, the second power supply unit 14 supplies the electric power to the light emitting unit 21 and achieves the effects of providing emergency illuminations and an indication of the escape direction.

In summation of the description above, the present invention effectively overcomes the shortcomings of the prior art, enhances the performance over the conventional structure and complies with the patent application requirements.

The present invention provides users a way of locating the position of a switch push-button in the dark under a normal use, and working together with a transparent cover 4 covered onto the exterior of the main frame 1 to achieve the effects of enhancing the light and making the cleaning easier. The invention further supplies electric power to maintain the illumination and indication functions in a power failure. Unlike the traditional panel of the push-button switch structure, the invention also shows a significant improvement of the configuration and effect of a power switch.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A push-button switch structure with an illumination function, comprising:
a main frame, having a panel disposed at the central area of said main frame and an installing portion disposed on said panel for installing at least one switch;
a circuit board, connected between said panel and said main frame, for detecting an external light by a light sensor and driving at least one light emitting unit installed around the periphery of said circuit board; and
a transparent cover, coupled to a lateral side of said main frame to form a cover, for connecting said switch.

2. The push-button switch structure with an illumination function of claim 1, wherein said circuit board is coupled to a second power supply unit, for supplying an electric power to said light emitting unit when an external power supply stops supplying power.

3. The push-button switch structure with an illumination function of claim 2, wherein said second power supply unit is in a configuration for connecting a battery compartment with a battery.

4. The push-button switch structure with an illumination function of claim 1, wherein said main frame has a reflecting surface disposed at an internal periphery of said main frame and extended obliquely inward.

5. The push-button switch structure with an illumination function of claim 1, wherein said main frame has at least one fixing portion disposed at the periphery of said main frame, such that said transparent cover can be coupled to a lateral surface of said main frame through at least one fixing portion disposed on a cover body to form a cover.

6. The push-button switch structure with an illumination function of claim 1, wherein said circuit board installs an enable switch for compulsorily turning off the power of said light emitting unit.

7. The push-button switch structure with an illumination function of claim 1, wherein said transparent cover has a planned area disposed on a surface of said transparent cover for changing the angle of refraction and enhancing the light emitting effect.
